(19) United States
(12) Patent Application Publication
(10) Pub. No.: US 2018/0090804 A1
(43) Pub. Date: Mar. 29, 2018

(54) RESONATOR AND FILTER

(71) Applicant: NIHON DENGYO KOSAKU CO., LTD., Tokyo (JP)

(72) Inventors: Ryuji YATSUDA, Tokyo (JP); Akira TASHIRO, Tokyo (JP)

(73) Assignee: NIHON DENGYO KOSAKU CO., LTD., Tokyo (JP)

(21) Appl. No.: 15/543,094

(22) PCT Filed: Nov. 19, 2015
(86) PCT No.: PCT/JP2015/082497

§ 371 Date: Jul. 12, 2017

(30) Foreign Application Priority Data
Jan. 13, 2015 (JP) 2015-004455
Jan. 13, 2015 (JP) 2015-004456

(51) Int. Cl. H01P 1/20; H01P 7/06; H01P 7/04; H01P 1/30

(52) U.S. Cl. CPC H01P 1/20; H01P 1/30; H01P 7/04; H01P 7/06

(57) ABSTRACT

A resonator 10 according to the present invention is provided with: an outer conductor 12 inside which a cavity 11 is formed; and an inner conductor 13 provided in the cavity 11 of the outer conductor 12. The inner conductor 13 includes: a movable body 133 provided to project into the cavity 11; a distal end portion 131 which is a separate member from the movable body 133 and which covers the distal end of the movable body 133, on the side of the movable body 133 that projects into the cavity 11; and a supporting rod 132 which is a rod-shaped member disposed inside the movable body 133, is provided with one end side fixed to the distal end portion 131 and the other end side fixed to the movable body 133, and which has a lower coefficient of thermal expansion than the movable body 133. By this means, it is possible to provide a resonator having a high temperature stability, which is applicable in multiple frequency bands, and a filter employing the resonator.

### TECHNICAL FIELD

The present invention relates to a resonator and a filter.

### BACKGROUND ART

In a broadcasting station, broadcasting signals are transmitted from a transmitter to an antenna through a filter, and become radio waves to be radiated. As such a filter, a band pass filter (BPF) is used in many cases, to allow signals of predetermined frequency bands included in the broadcasting signals to pass and to suppress passing of other frequency components. Such a filter can be configured by a resonator using a cavity.

Characteristics of the frequency bands passed by the filter are required to have high temperature stability that is not fluctuated by changes in temperature (with small temperature drift) caused by environmental temperature or heat generation.

In Non-Patent Document 1, a simple method for absolute temperature compensation of a tunable resonant cavity which exhibits linearity in tuning, at least over a narrow but useful frequency range, and for which a linear law relates the frequency change to the temperature change of at least 30° C. around the reference temperature is described.

### CITATION LIST

### Non-Patent Literature

Non-Patent Document 1: S. A. Adeniran, “A new technique for absolute temperature compensation of tunable resonant cavities”, IEE Proceedings H, Volume: 132, Issue: 7, December 1985, p. 471

### SUMMARY OF INVENTION

### Technical Problem

By the way, resonators have been required to be adaptable to use in multiple frequency bands, and to have high temperature stability in these frequency bands.

An object of the present invention is to provide a resonator that is adaptable to multiple frequency bands and has high temperature stability, and a filter using the resonator.

Moreover, in addition to adaptability to use in multiple frequency bands, resonators have been required to suppress reduction of a Qu value while enduring mechanical vibrations.

An object of the present invention is to provide a resonator that has high vibration proof and is capable of suppressing reduction of a Qu value, and a filter using the resonator.

### Solution to Problem

Under such an object, a resonator to which the present invention is applied includes: an outer conductor that forms a cavity inside thereof; and an inner conductor provided in the cavity of the outer conductor, wherein the inner conductor includes: a hollow member provided to project into the cavity; a covering member that is a separate member from the hollow member and covers a distal end in the hollow member, which is on a side projecting into the cavity; and a supporting rod that is a rod-shaped member disposed inside the hollow member and provided with one end side thereof being fixed to the covering member and the other end side being fixed to the hollow member, the supporting rod having a coefficient of thermal expansion lower than a coefficient of thermal expansion of the hollow member.

Here, the covering member covers the distal end and an outer circumferential side surface of the distal end side of the hollow member, and the outer circumferential side surface of the hollow member slidably supports the covering member along the projecting direction. In this case, the position of the covering member with respect to the hollow member becomes stable.

Moreover, the distal end side of the hollow member is elastically more deformable than a root side of the hollow member. In this case, electrical connection between the covering member and the hollow member is maintained.

Moreover, a position of the hollow member in the projecting direction in the cavity is adjustable, and the hollow member is fixed to the outer conductor at an intermediate position located between the one end and the other end of the supporting rod in the projecting direction. In this case, a resonance frequency becomes adjustable while a temperature compensation amount is adjusted.

Moreover, the inner conductor includes a supporting body that is fixed to the outer conductor in the cavity and supports the hollow member while being penetrated by the hollow member, and the hollow member and the supporting body include screw grooves on respective surfaces facing each other, and the supporting body supports the hollow member by engaging the screw grooves each other. In this case, adjustment of the resonance frequency of the resonator is made easier.

Moreover, from another standpoint, a filter to which the present invention is applied includes: an input unit to which a signal is inputted; an output unit from which a signal is outputted; and a resonator that is connected to the input unit and the output unit, and includes an outer conductor forming a cavity inside thereof and an inner conductor provided in the cavity of the outer conductor, wherein the inner conductor includes: a hollow member provided to project into the cavity; a covering member that is a separate member from the hollow member and covers a distal end in the hollow member, which is on a side projecting into the cavity; and a supporting rod that is a rod-shaped member disposed inside the hollow member and provided with one end side thereof being fixed to the covering member and the other end side being fixed to the hollow member, the supporting rod having a coefficient of thermal expansion lower than a coefficient of thermal expansion of the hollow member.

Moreover, a resonator to which the present invention is applied includes: an outer conductor that forms a cavity inside thereof; and an inner conductor provided to project into the cavity of the outer conductor, a position of the inner conductor inside the cavity being adjustable, wherein the inner conductor includes a screw groove formed on an outer circumferential surface of the inner conductor along a circumferential direction of the inner conductor to allow for adjustment of the position, and a region where the screw groove is formed includes a discontinuous portion in which the screw groove is not continuous in the circumferential direction.

Here, the discontinuous portion is formed to have a longitudinal direction of the discontinuous portion along the projecting direction on the outer circumferential surface of the inner conductor. In this case, an operation to form the discontinuous portion is made easier.

Moreover, the multiple discontinuous portions are provided at positions different from one another in the circumferential direction. In this case, positional shift of the inner conductor is suppressed.

Moreover, the inner conductor includes: a main body that is movable in the projecting direction inside the cavity and includes the screw groove on an outer circumferential surface thereof; and a supporting body that is fixed to the outer conductor inside the cavity and supports the main body while being penetrated by the main body, wherein the supporting body includes another screw groove, which engages the screw groove, on an inner circumferential surface facing the main body that penetrates the supporting body. In this case, an area of the screw groove formed on the main body to project into the cavity is suppressed.

Moreover, the inner conductor includes a rotation suppressing member that suppresses rotation of the main body with respect to the supporting body. In this case, unintentional change in the resonance frequency of the resonator is suppressed.

Moreover, from another standpoint, a filter to which the present invention is applied includes: an input unit to which a signal is inputted; an output unit from which a signal is outputted; and a resonator that is connected to the input unit and the output unit, and includes an outer conductor forming a cavity inside thereof and an inner conductor provided inside the cavity of the outer conductor, a position of the inner conductor in the cavity being adjustable, wherein the inner conductor includes a screw groove formed on an outer circumferential surface of the inner conductor along a circumferential direction of the inner conductor to allow for adjustment of the position, and a region where the screw groove is formed includes a discontinuous portion in which the screw groove is not continuous in the circumferential direction.

### Advantageous Effects of Invention

According to the present invention, it is possible to provide a resonator having a high temperature stability, which is applicable in multiple frequency bands, and a filter employing the resonator.

Moreover, according to the present invention, it is possible to provide a resonator that has high vibration proof and is capable of suppressing reduction of a Qu value, and a filter using the resonator.

### BRIEF DESCRIPTION OF DRAWINGS

FIG. 1 is a diagram illustrating a filter in transmitting broadcasting signals;

FIG. 2 is a perspective view of a filter in an exemplary embodiment;

FIGS. 3A and 3B are a plan view and a cross-sectional view, respectively, for illustrating a configuration of a resonator;

FIG. 4 is an exploded perspective view illustrating a configuration of an inner conductor;

FIGS. 5A to 5E are cross-sectional views illustrating members constituting the inner conductor;

FIGS. 6A and 6B are a top view and a bottom view, respectively, for illustrating a configuration of a movable body;

FIGS. 7A and 7B are diagrams showing the resonator in different passing frequency bands;

FIGS. 8A to 8C are diagrams for illustrating temperature compensation in the resonator;

FIGS. 9A and 9B are diagrams for illustrating a relationship between the passing frequency band and a temperature compensation amount in the resonator;

FIGS. 10A and 10B are diagrams for illustrating sliding movement of a distal end portion;

FIG. 11 is a diagram showing temperature change in attenuation when a center frequency f0 is set to 474 MHz (low frequency band) in the filter;

FIG. 12 is a diagram showing temperature change in attenuation when the center frequency f0 is set to 850 MHz (high frequency band) in the filter;

FIG. 13 is a diagram showing temperature change in attenuation when the center frequency f0 is set to 863 MHz (high frequency band) in a single resonator;

FIGS. 14A to 14C are diagrams illustrating modified examples in the exemplary embodiment; and

FIGS. 15D to 15F are diagrams illustrating modified examples in the exemplary embodiment.

### DESCRIPTION OF EMBODIMENTS

Hereinafter, an exemplary embodiment according to the present invention will be described in detail with reference to attached drawings.

Here, a filter and a resonator will be described by taking broadcasting signals in a broadcasting station as an example; however, the filter and the resonator may be those used for passing a signal of a predetermined frequency band in other high frequency signals, not limited to the broadcasting signals.

### <Filter 100>

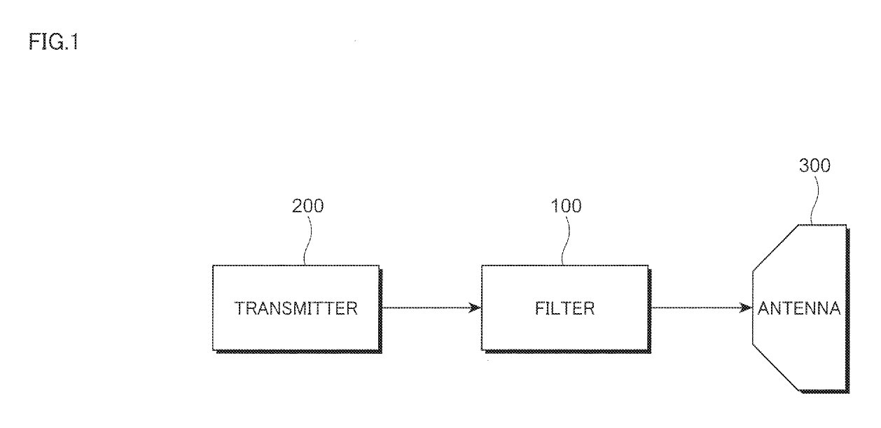

FIG. 1 is a diagram illustrating a filter 100 in transmitting broadcasting signals.

The broadcasting signals are transmitted from a transmitter 200 to an antenna 300 through the filter 100, and are radiated from the antenna 300 as radio waves.

The filter 100 is a band pass filter (BPF) that allows signals of predetermined frequency bands, of the broadcasting signals inputted from the transmitter 200, to pass and suppresses passing of other frequency components.

Note that, since the filter and the resonator in the exemplary embodiment are not limited to those for the broadcasting signals as described above, hereinafter, the signals will be described as signals.

Moreover, hereinafter, the frequency bands that are allowed to pass will be described as passing frequency bands.

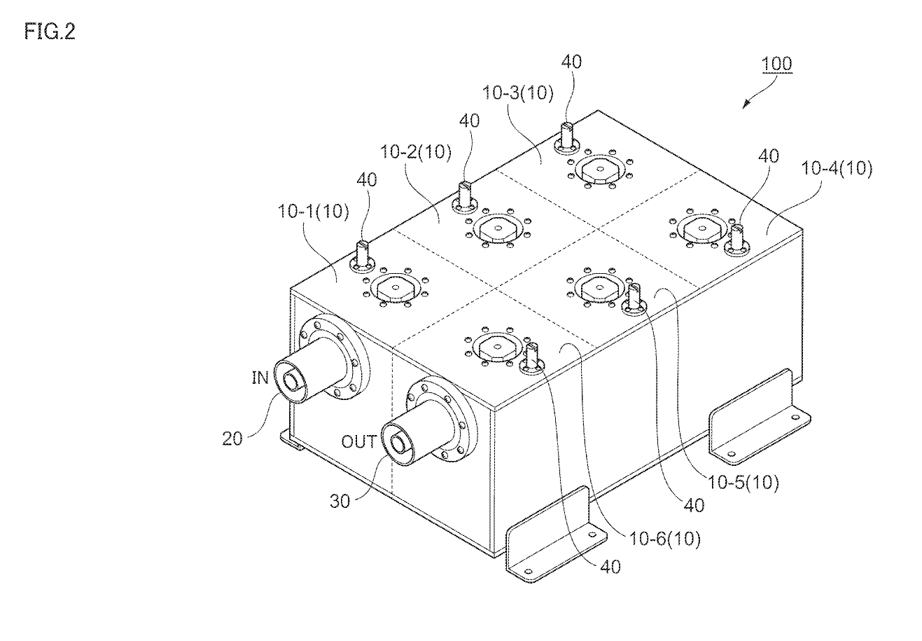

FIG. 2 is a perspective view of the filter 100 in the exemplary embodiment.

As shown in FIG. 2, the filter 100 in the exemplary embodiment is configured with multiple resonators 10.

To describe further, as an example, the filter 100 is configured by coupling six resonators 10 (when each is to be distinguished, described as resonators 10-1 to 10-6). Then, the filter 100 includes an input terminal 20 as an example of an input unit to which a signal is inputted, and an output terminal 30 as an example of an output unit from which a signal is outputted. Moreover, the filter 100 includes fine-adjustment screws 40 that are provided to respective resonators 10 to make a resonance frequency of each resonator 10 finely adjustable.

In the filter 100, a signal inputted to the input terminal 20 propagates the resonators 10-1 to 10-6 and is outputted from the output terminal 30.

Note that, in the example shown in the figure, the input terminal 20 is connected to the resonator 10-1, and the output terminal 30 is connected to the resonator 10-6. Moreover, between the respective resonators 10-1 to 10-6, coupling mechanisms (not shown) are provided, and thereby the resonators are configured to propagate the signals. To describe further, the coupling mechanisms are provided between the resonator 10-1 and the resonator 10-2, between the resonator 10-2 and the resonator 10-3, between the resonator 10-3 and the resonator 10-4, between the resonator 10-4 and the resonator 10-5, and between the resonator 10-5 and the resonator 10-6.

Here, it may be sufficient that the predetermined passing frequency bands are obtained by mutually coupling the multiple resonators 10 by the coupling mechanisms, and the coupling mechanisms may be provided between any of the multiple resonators 10. For example, to be different from the example shown in the figure, the coupling mechanisms may be provided between the resonator 10-1 and the resonator 10-6, and between the resonator 10-2 and the resonator 10-5.

By the way, in FIG. 2, the filter 100 is configured by coupling six cases of (6) resonators 10. The number of cases of the resonators 10 to be coupled has an effect on steepness of the passing frequency band. To describe further, the larger the number of cases of the resonators 10 is, the higher the steepness of the passing frequency band becomes. On the other hand, when the number of cases is increased, loss is also increased. Consequently, the number of cases of the resonators 10 is set in accordance with required steepness of the passing frequency band. To describe further, for example, the filter 100 may be configured with one case of (1) resonator 10.

Note that the steepness of the passing frequency band means that a width of the frequency band on a border between the frequency to be passed and the frequency not to be passed is narrow.

Moreover, as the above-described coupling mechanism, a publicly known technique may be applied, and therefore, description thereof is omitted here.

### <Resonator 10>

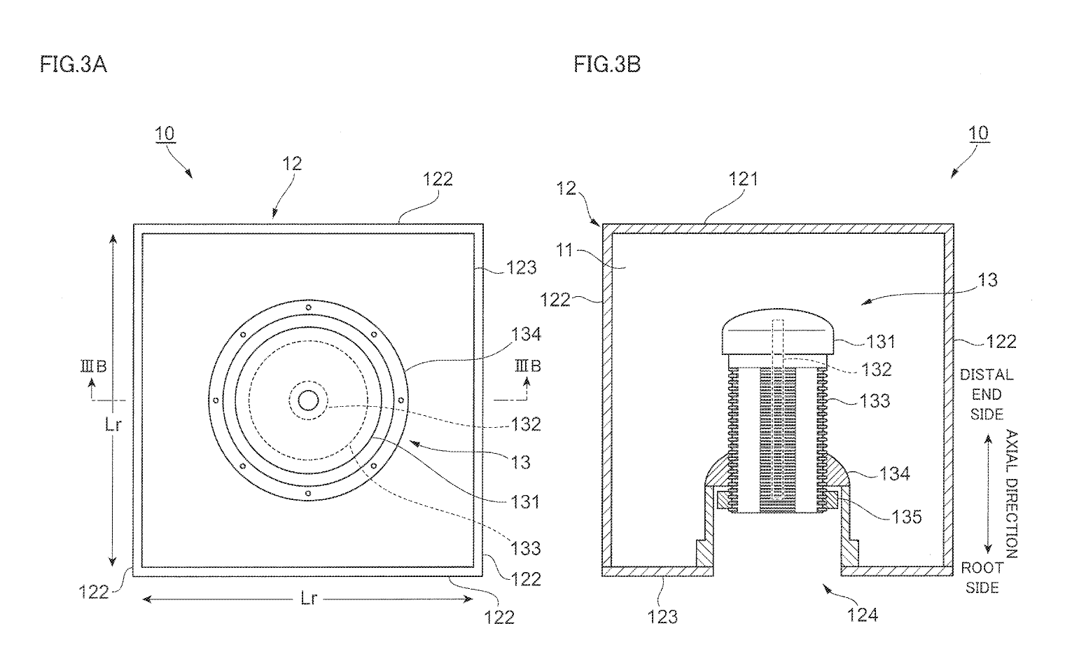

FIGS. 3A and 3B are a plan view and a cross-sectional view, respectively, for illustrating a configuration of the resonator 10. To describe further, FIG. 3A is a plan view of the resonator 10, and FIG. 3B is a cross-sectional view along the IIIB-IIIB line in FIG. 3A.

Note that, in FIG. 3A, illustration of a facing surface portion 121 is omitted. Moreover, in FIG. 3B, a distal end portion 131 and a movable body 133 are illustrated as in a side view, not in the cross-sectional view, for the sake of convenience. Moreover, in FIGS. 3A and 3B, illustration of the input terminal 20, the output terminal 30, the fine-adjustment screws 40 or the coupling mechanisms is omitted.

As shown in FIGS. 3A and 3B, the resonator 10 includes an outer conductor 12 forming a cavity 11 inside thereof and an inner conductor 13 provided in the cavity 11 formed by the outer conductor 12. Here, the outer conductor 12 constitutes a housing of the resonator 10.

Note that the resonator 10 is not limited to the disposition in the orientation shown in FIGS. 3A and 3B; however, for example, the resonator 10 may be disposed to turn the resonator 10 shown in FIG. 3B upside down, or may be disposed at an inclination with respect to the vertical direction.

### <Outer Conductor 12>

Next, with reference to FIGS. 3A and 3B, the outer conductor 12 will be described.

As shown in FIGS. 3A and 3B, the outer conductor 12 includes the facing surface portion 121, side surface sections 122 and a supporting surface portion 123.

Here, as shown in FIG. 3B, an outer shape of the facing surface portion 121 and the supporting surface portion 123 of the outer conductor 12 is square. In other words, the cavity 11 enclosed by the outer conductor 12 is a rectangular parallelepiped. Note that the outer conductor 12 may be in other shapes. For example, the outer conductor 12 may be in a shape of a rectangular parallelepiped with a rectangular bottom surface, or in a cubic shape. Further, the outer conductor 12 may be in a cylindrical shape or in an elliptic cylindrical shape.

Moreover, the supporting surface portion 123 is provided with an opening section 124 in a circular shape. Though details will be described later, the inner conductor 13 is provided to the opening section 124.

Note that, though illustration is omitted, when the input terminal 20, the output terminal 30 or the coupling mechanisms are provided, for example, the input terminal 20, the output terminal 30 or the coupling mechanisms may be provided in an opening provided to the side surface section 122 of the outer conductor 12. Moreover, when the fine-adjustment screws 40 are provided, for example, the fine-adjustment screws 40 may be provided in an opening provided to the supporting surface portion 123.

### <Inner Conductor 13>

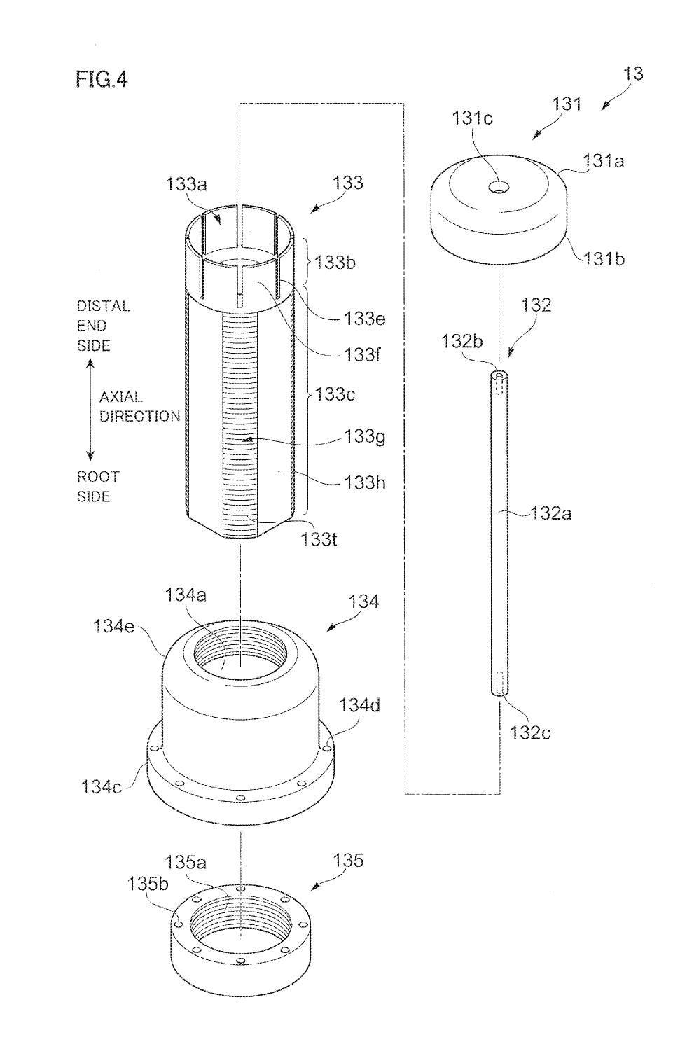

FIG. 4 is an exploded perspective view illustrating a configuration of the inner conductor 13.

Next, with reference to FIGS. 3 and 4, the inner conductor 13 will be described.

As shown in FIGS. 3A and 3B, the inner conductor 13 is a member in substantially a columnar outer shape. The inner conductor 13 is provided to the opening section 124 of the outer conductor 12. To describe further, the inner conductor 13 is provided to cover the opening section 124 of the outer conductor 12 from the inside of the cavity 11, and is disposed to protrude into the cavity 11 formed by the outer conductor 12. The inner conductor 13 has a function of an adjustment screw for setting a frequency band to be used, and also a function of suppressing frequency change caused by temperature change of the resonator 10 due to environment or heat generation (temperature drift), that is, a function of performing temperature compensation (details will be described later).

Here, the inner conductor 13 in the example shown in the figure is disposed in the cavity 11 with the longitudinal direction (axial direction) thereof being in the vertical direction. In the following description, the axial direction of the inner conductor 13 is simply referred to as the axial direction in some cases. Moreover, in the axial direction of the inner conductor 13, a distal end side of the inner conductor 13 is simply referred to as a distal end side, and a root side of the inner conductor 13 is simply referred to as a root side in some cases. Moreover, a circumferential direction around the axis of the inner conductor 13 is simply referred to as a circumferential direction in some cases.

As shown in FIG. 4, the inner conductor 13 includes: a distal end portion 131; a supporting rod 132; a movable body 133; a supporting body 134; and a fixing plate 135.

Hereinafter, with reference to FIGS. 4 to 6, each of these constituting members constituting the inner conductor 13 will be described.

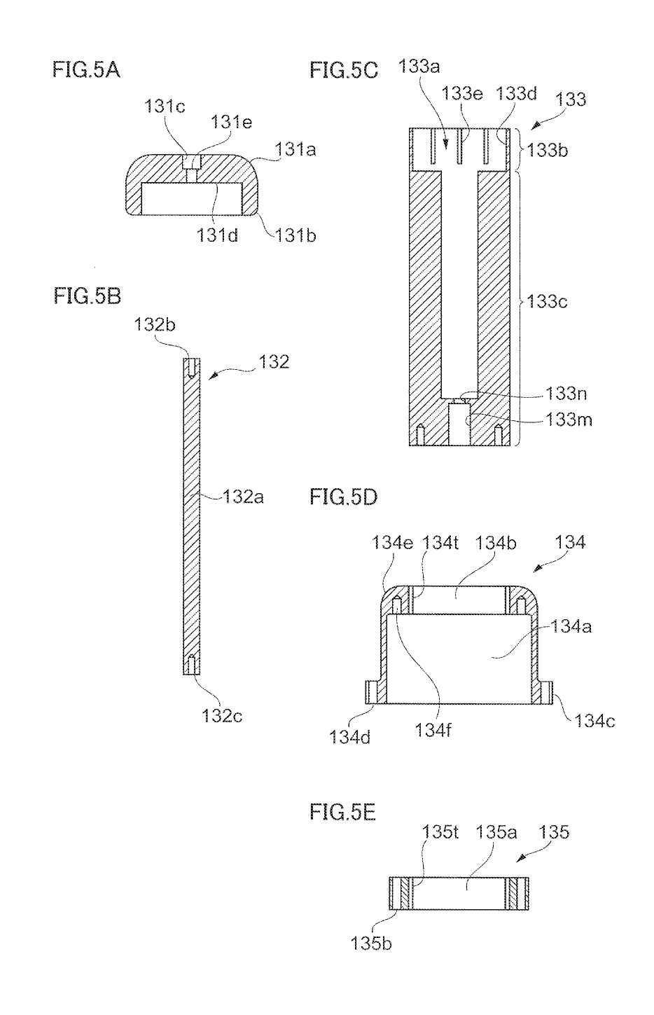

FIGS. 5A to 5E are cross-sectional views illustrating the members constituting the inner conductor 13. To describe further, FIG. 5A is a cross-sectional view of the distal end portion 131, FIG. 5B is a cross-sectional view of the supporting rod 132, FIG. 5C is a cross-sectional view of the movable body 133, FIG. 5D is a cross-sectional view of the supporting body 134, and FIG. 5E is a cross-sectional view of the fixing plate 135.

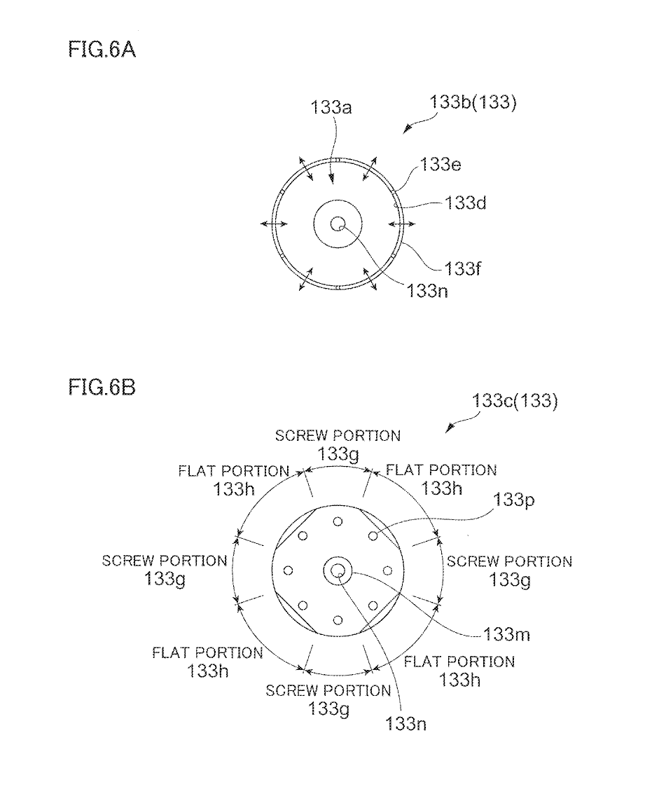

FIGS. 6A and 6B are a top view and a bottom view, respectively, for illustrating a configuration of the movable body 133. To describe further, FIG. 6A is the top view of the movable body 133, and FIG. 6B is bottom view of the movable body 133.

### <Distal End Portion 131>

As shown in FIG. 4, the distal end portion 131, which is an example of a covering member, is a disk-shaped member. In the distal end portion 131 in the shown example, each of a distal end side edge 131a and a root side edge 131b in the axial direction is processed in a round shape.

Moreover, as shown in FIG. 5A, the distal end portion 131 includes: a first concave portion 131c formed in a center portion on a distal end side surface; a second concave portion 131d formed in a center portion on a root side surface; and a through hole 131e that makes the first concave portion 131c and the second concave portion 131d continuous in the axial direction.

Note that, due to the distal end side edge 131a in the inner conductor 13 processed in a round shape, discharge between the distal end portion 131 and the outer conductor 12 (for example, between the distal end portion 131 and the facing surface portion 121) is suppressed. In the shown example, the shape of the distal end side edge 131a of the inner conductor 13 is determined in a dimension providing electric field intensity of 3.0 kV/mm or less. This makes it possible to handle high-power signals in the filter 100.

### <Supporting Rod 132>

As shown in FIGS. 4 and 5B, the supporting rod 132 is in a columnar shape, and is a so-called rod-shaped member. The supporting rod 132 includes: a main body 132a; and a first screw hole 132b and a second screw hole 132c formed on end surfaces on a distal end side and a root side, respectively.

Note that the supporting rod 132 is a columnar-shaped rod; however, the supporting rod 132 may be in other shapes, such as a rod in a rectangular-columnar shape. To describe further, the cross-sectional shape of the supporting rod 132 is not limited to the circular shape; and the cross-sectional shape may be any shape, such as an elliptical shape or a polygonal shape.

### <Movable Body 133>

As shown in FIG. 4, the movable body 133, as an example of a main body and a hollow member, is a member that forms a space 133a inside thereof and in a shape of a bottomed cylinder with a distal end side thereof being opened and a root side thereof being covered. The movable body 133 includes: a slide supporting portion 133b positioned at the distal end side; and a fixed portion 133c positioned closer to the root side than the slide supporting portion 133b. Here, on the outer circumferential surface of the fixed portion 133c, screw grooves 133t are formed along the circumferential direction; on the other hand, the screw grooves 133t are not formed on the outer circumferential surface of the slide supporting portion 133b. Note that the fixed portion 133c is an example of a region where the screw grooves 133t are formed.

Moreover, as shown in FIG. 4, the slide supporting portion 133b includes slits 133e extending in the axial direction from the distal end side. In the shown example, multiple (6) slits 133e are formed to be separate from one another (disposed) in the circumferential direction. In other words, due to the multiple (6) slits 133e being formed, the slide supporting portion 133b has a configuration including multiple (6) small-piece portions 133f. The small-piece portions 133f are formed to be separate from one another (disposed) in the circumferential direction.

Moreover, as shown in FIG. 5C, the movable body 133 includes: a third concave portion 133m formed in a center portion on a root side surface; and a through hole 133n that makes the third concave portion 133m and a space 133a continuous.

Moreover, the slide supporting portion 133b has an outer diameter that coincides with (corresponds to) an outer diameter of the fixed portion 133c. Moreover, the slide supporting portion 133b includes a large-diameter portion 133d in which a diameter of the space 133a formed inside thereof is large as compared to the fixed portion 133c. Consequently, as compared to the fixed portion 133c, the slide supporting portion 133b is thin in the diameter direction; accordingly, the slide supporting portion 133b is elastically more deformable in the diameter direction.

Here, as shown in FIG. 6A, each of the multiple small-piece portions 133f is, due to elastic deformation, movable in the diameter direction of the slide supporting portion 133b (refer to arrows in the figure). To describe further, the slide supporting portion 133b is configured such that the diameter thereof is variable (contractible).

Returning to FIG. 4 again, the fixed portion 133c of the exemplary embodiment includes, in the circumferential direction, a part where the screw grooves 133t are formed and a part where the screw grooves 133t are not formed. In other words, the screw grooves 133t are not continuous in the circumferential direction.

To describe further with reference to FIG. 6B, the fixed portion 133c includes screw portions 133g and flat portions 133h at positions adjacent to each other in the circumferential direction. Here, while the screw portions 133g are regions in the fixed portion 133c where the screw grooves 133t are formed, the flat portions 133h are regions in the fixed portion 133c where the screw grooves 133t are not formed. The flat portion 133h is an example of a discontinuous portion where the screw grooves 133t are not continued.

The flat portion 133h is a portion corresponding to a so-called D cut, and is a flat surface portion formed on the outer circumferential surface of the fixed portion 133c. In other words, the flat portion 133h is a region substantially in a flat surface shape, the longitudinal direction thereof extending in the axial direction. Here, the flat portion 133h can be grasped as, for example, a portion having fewer irregularities than the screw portion 133g. Moreover, the flat portion 133h can be grasped as a region that does not generate a force for fixing the movable body 133 to the supporting body 134. To describe additionally, with the longitudinal direction of the flat portion 133h being along the axial direction, it becomes easy to perform operation of forming the flat portion 133h.

By the way, as shown in FIG. 6B, the fixed portion 133c includes multiple (4) screw portions 133g and the flat portions 133h alternately disposed in the circumferential direction. Moreover, in the shown example, the screw portions 133g are disposed at respective positions facing each other across the center axis of the movable body 133. Moreover, the flat portions 133h are disposed at respective positions facing each other across the center axis of the movable body 133. Further, regarding the length in the circumferential direction, the length in the flat portion 133h is longer than that in the screw portion 133g.

Note that, as in the shown example, due to the configuration in which the multiple (4) flat portions 133h are disposed in the circumferential direction in the movable body 133, it is possible to stably maintain electrical connection between the movable body 133 and the supporting body 134, as compared to, for example, a configuration in which a single flat portion (not shown) that has a length in the circumferential direction equal to the sum total of the four flat portions 133h is formed. Moreover, it is possible to suppress shift of relative positions of the movable body 133 and the supporting body 134.

### <Supporting Body 134>

As shown in FIGS. 4 and 5D, the supporting body 134 is a cylindrical member that forms a space 134a inside thereof with a distal end side thereof being partially covered and a root side thereof being opened.

The supporting body 134 includes a through hole 134b formed at the center of the distal end side surface in a dimension corresponding to the outer diameter of the movable body 133. Moreover, the supporting body 134 includes the screw grooves 134t formed along the circumferential direction on an inner circumferential surface of the through hole 134b to engage the screw grooves 133t of the movable body 133. Note that the screw grooves 134t are an example of other screw grooves.

Moreover, the supporting body 134 includes: a flange portion 134c formed on the outer circumferential surface on the root side; and screw holes 134d penetrating the flange portion 134c in the axial direction. Moreover, in the shown example, the distal end side edge 134e in the axial direction of the supporting body 134 is processed in a round shape.

Further, the supporting body 134 includes multiple screw holes 134f on a surface covering the distal end side. The screw holes 134f are formed along the circumferential direction on the surface facing the space 134a. The screw holes 134f are formed to extend from the root side toward the distal end side.

Here, as shown in FIGS. 4 and 5D, the screw grooves 134t are not formed on the outer circumferential surface of the supporting body 134.

Moreover, the screw grooves 134t are formed on the inner circumferential surface of the through hole 134b formed in the supporting body 134; on the other hand, the screw grooves 134t are not formed on the inner circumferential surface of the supporting body 134 positioned closer to the root side than the through hole 134b. Note that the inner diameter of the space 134a in the shown example is larger than the inner diameter of the through hole 134b.

Further, the screw grooves 134t formed on the inner circumferential surface of the through hole 134b are formed continuously in the circumferential direction. To describe further, different from the fixed portion 133c of the above-described movable body 133, the inner circumferential surface of the through hole 134b does not include the discontinuous portion of the screw grooves 133t in the circumferential direction.

### <Fixing Plate 135>

As shown in FIGS. 4 and 5E, the fixing plate 135 is a plate-like member in an annular shape. The inner diameter of the fixing plate 135 is formed in a dimension corresponding to the outer diameter of the movable body 133.

Moreover, the fixing plate 135 includes screw grooves 135t formed along the circumferential direction on an inner circumferential surface 135a to engage the screw grooves 133t of the movable body 133. Note that the screw grooves 135t are formed continuously in the circumferential direction.

Moreover, the fixing plate 135 includes multiple through holes 135b along the circumferential direction, the through holes 135b penetrating in the axial direction. Note that the through holes 135b are formed at positions facing the respective through holes 134f of the supporting body 134.

### <Relationship Among Members in Inner Conductor 13>

Next, with reference to FIGS. 3 to 5, a positional relationship among the members constituting the inner conductor 13 in a state where the inner conductor 13 is assembled will be described.

First, the distal end portion 131 is disposed to cover the opened distal end side of the movable body 133. At this time, the distal end portion 131 is provided to the distal end of the movable body 133 so that the position thereof in the axial direction can be displaced.

Specifically, the slide supporting portion 133b of the movable body 133 is inserted into the second concave portion 131d of the distal end portion 131. Consequently, the slide supporting portion 133b supports the distal end portion 131 slidably in the axial direction.

Note that, though the description is omitted above, the inner diameter of the second concave portion 131d of the distal end portion 131 and the outer diameter of the slide supporting portion 133b are in a dimension such that, in a state where the slide supporting portion 133b is inserted (disposed) into the second concave portion 131b, the distal end portion 131 is limited in moving in the diameter direction and is movable in the axial direction.

Moreover, since the small-piece portions 133f are elastically deformed in the diameter direction, resistance in sliding movement of the slide supporting portion 133b in the axial direction is reduced.

To additionally describe, by insertion of the slide supporting portion 133b of the movable body 133 into the second concave portion 131d of the distal end portion 131, the relative position of the distal end portion 131 with respect to the slide supporting portion 133b becomes stable.

Incidentally, the distal end portion 131 and the movable body 133 are respectively fixed to both ends of the supporting rod 132 via bolts (fixing tools, not shown).

Specifically, a bolt (not shown) is disposed to penetrate from the distal end side of the distal end portion 131 (the first concave portion 131c side) to the second concave portion 131d side via the through hole 131e. Then, by inserting the distal end of the bolt into the first screw hole 132b formed on the distal end side of the supporting rod 132, the distal end portion 131 is fixed (connected) to the supporting rod 132.

Moreover, another bolt (not shown) is disposed to penetrate from the root side of the movable body 133 (the third concave portion 133m side) to the space 133a side via the through hole 133n. Then, by inserting the distal end of the bolt (not shown) into the second screw hole 132c formed on the root side of the supporting rod 132, the movable body 133 is fixed to the supporting rod 132.

Note that the supporting rod 132 is in a state of being fixed to the movable body 133 via the bolts (not shown). The supporting rod 132 is fixed to an end portion opposite to the slide supporting portion 133b in the movable body 133, in other words, a bottom portion side of the movable body 133. Here, the bottom portion of the movable body 133 is not limited to a portion that covers an end of the movable body 133 formed as the hollow member; however, the bottom portion may be a part of the movable body 133 and positioned on an opposite side of the slide supporting portion 133b across the center of the longitudinal direction of the movable body 133.

Moreover, the movable body 133 is provided so that the root side thereof is inserted into the supporting body 134 and the position thereof with respect to the supporting body 134 in the axial direction can be displaced.

Specifically, the root side of the movable body 133 is inserted into the through hole 134b of the supporting body 134. Here, the screw grooves 133t formed on the outer circumferential surface of the movable body 133 are engaged with the screw grooves 134t formed on the inner circumferential surface of the through hole 134b of the supporting body 134. Then, in this state, by rotating the movable body 133 in the circumferential direction, the relative positions in the axial direction of the movable body 133 and the supporting body 134 are changed.

Note that, in the exemplary embodiment, the supporting body 134 is provided in the cavity 11, and the movable body 133 is supported by the distal end side of the supporting body 134. Accordingly, an amount of projection of the movable body 133 outside of the supporting surface portion 123 of the outer conductor 12 is suppressed.

Moreover, the supporting body 134 can be grasped as a configuration that covers the outer circumference of the root side of the movable body 133 (a part of the movable body 133). Then, as described above, since the supporting body 134 covers the part of the movable body 133, an area of the screw grooves 133t formed on the movable body 133 to be inserted into the cavity 11 is suppressed.

Moreover, as described above, the flat portions 133h are formed on the movable body 133, and thereby the screw grooves 133t of the movable body 133 are not continuous partially in the circumferential direction; on the other hand, the screw grooves 134t of the supporting body 134 are formed in an annular shape to be continuous in the circumferential direction. Consequently, for example, different from the shown example, displacement in the axial direction, which possibly occurs when the configuration including the screw grooves 134t of the supporting body 134 that are not partially continuous in the circumferential direction, is suppressed.

To describe further, in the configuration where the screw grooves 134t of the supporting body 134 are not continuous in this manner, depending on an attachment angle resulting from rotation of the movable body 133 in the circumferential direction, a state possibly occurs in which a part of the supporting body 134 where the screw grooves 134t are not formed and a part of the movable body 133 where the screw grooves 133t are not formed (the flat portion 133h) face each other. In this case, there occurs a possibility that the screw grooves 133t and the screw grooves 134t are not engaged, and the relative positions of the supporting body 134 and the movable body 133 in the axial direction are shifted. In the exemplary embodiment, to suppress the positional shift in the axial direction, the screw grooves 134t of the supporting body 134 are formed continuously in the circumferential direction.

By the way, in the state where the root side of the movable body 133 is inserted into the supporting body 134 and positional adjustment of the movable body 133 in the axial direction (details will be described later) has been completed, the fixing plate 135 is attached to the movable body 133 and the supporting body 134. This suppresses the displacement of the movable body 133 with respect to the supporting body 134.

Specifically, the fixing plate 135 is attached to the movable body 133 inserted into the space 134a via the through hole 134b, and the screw grooves 133t of the movable body 133 and the screw grooves 135t of the fixing plate 135 are engaged. Then, in the state where the screw grooves 133t and the screw grooves 135t are engaged, the through holes 135b of the fixing plate 135 are penetrated by the bolts (not shown), and thereafter, the bolts are inserted into the screw holes 134f of the supporting body 134 for fixing. This suppresses movement (rotation) of the movable body 133 in the circumferential direction via the fixing plate 135 and the bolts.

Note that, as shown in FIG. 3B, the supporting body 134 and the fixing plate 135 are fixed in the state of being separated in the axial direction. Accordingly, the movable body 133 is brought into a state of being fixed by a so-called double nut. Moreover, the fixing plate 135 is an example of a rotation suppressing member.

By the way, though the description is omitted above, the inner conductor 13 is fixed to the outer conductor 12 via the supporting body 134.

Specifically, as shown in FIG. 3B, bolts (not shown) are inserted into screw holes (not shown) formed on the supporting surface portion 123 of the outer conductor 12, and then further inserted into the screw holes 134d formed in the supporting body 134 of the inner conductor 13 for fixing. Consequently, the supporting body 134 (the inner conductor 13) is fixed to the outer conductor 12.

### <Materials>

Next, an example of materials constituting the resonator 10 will be described.

The outer conductor 12 is configured by metals, which are conducting materials, such as, specifically, aluminum (Al), iron (Fe), and copper (Cu).

Moreover, members other than the supporting rod 132 and the fixing plate 135 in the inner conductor 13, namely, the distal end portion 131, the movable body 133 and the supporting body 134 are configured by metals that are the conducting materials, such as, specifically, aluminum, iron, copper or the like. Moreover, these metals may be subjected to plate processing with silver (Ag) or the like.

On the other hand, as compared to the outer conductor 12, the distal end portion 131, the movable body 133, the supporting body 134 and the fixing plate 135 (hereinafter, in some cases referred to as the outer conductor 12 or others), the supporting rod 132 is configured by a material with a small coefficient of thermal expansion (coefficient of linear expansion). For example, the supporting rod 132 is configured with metal materials with a coefficient of thermal expansion smaller than that of aluminum, iron, copper or the like constituting the outer conductor 12 or others, such as, specifically, Invar (registered trademark) (invariable steel), carbon steel or the like.

Note that the supporting rod 132 may have a deformation amount with temperature change smaller than those of the outer conductor 12 or others, or may have a configuration combining the above-described materials.

Moreover, the fixing plate 135 is configured by a metal (specifically, aluminum, iron, copper or the like) in the exemplary embodiment; however, as long as secure fixing is provided, the fixing plate 135 may be made of a material other than metal (specifically, resin or the like).

### <Adjustment of Resonance Frequency of Resonator 10>

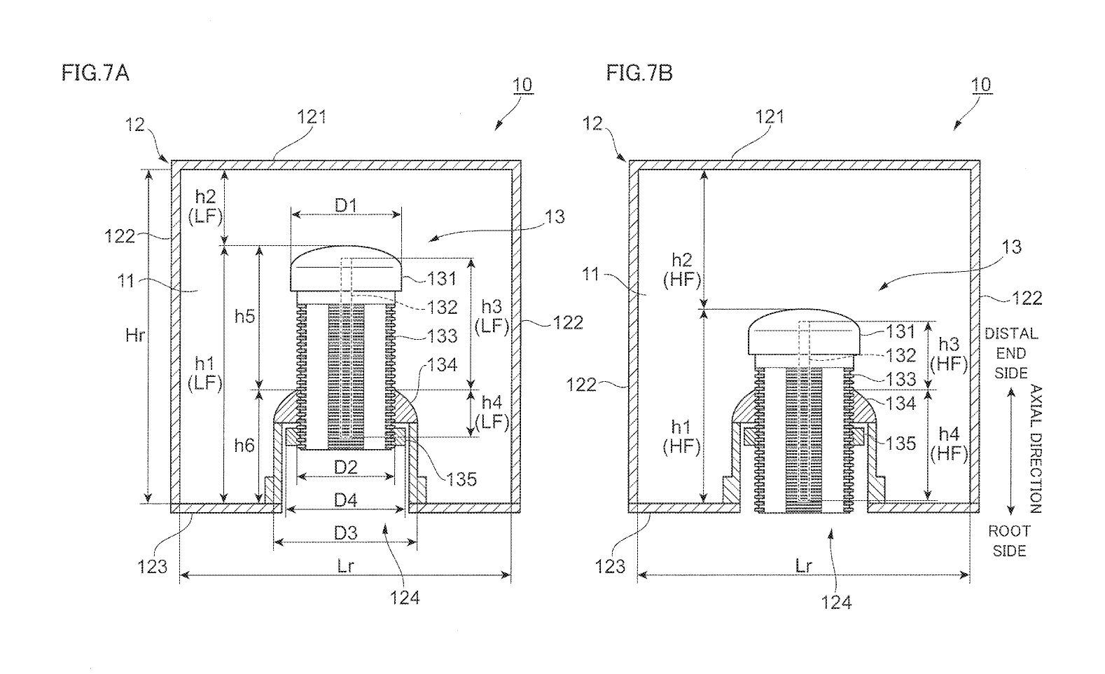

FIGS. 7A and 7B are diagrams showing the resonator 10 in different passing frequency bands. To describe further, FIG. 7A shows a case in which the frequency band is low (the low frequency band) and FIG. 7B shows a case in which the frequency band is high (the high frequency band).

Note that, as shown in FIG. 7A, the cavity 11 in the outer conductor 12 has a length of one side of Lr and a height of Hr. Moreover, as the dimension of each member constituting the inner conductor 13, it is supposed that the outer diameter of the distal end portion 131 is D1, the outer diameter of the movable body 133 is D2, the outer diameter of the main body of the supporting body 134 is D3 and the outer diameter of the fixing plate 135 is D4.

Moreover, it is supposed that the distance from the supporting surface portion 123 of the outer conductor 12 to the distal end of the distal end portion 131 of the inner conductor 13 is h1, and the distance from the distal end of the distal end portion 131 of the inner conductor 13 to the facing surface portion 121 of the outer conductor 12 is h2. Moreover, it is supposed that the distance in the axial direction from the distal end of the supporting body 134 to the distal end of the supporting rod 132 is h3, and the distance in the axial direction from the distal end of the supporting body 134 to the root of the supporting rod 132 is h4. Moreover, it is supposed that the distance in the axial direction from the distal end of the supporting body 134 to the distal end of the distal end portion 131 is h5, and the distance in the axial direction from the supporting surface portion 123 to the distal end of the supporting body 134 is h6.

Moreover, in the exemplary embodiment, the low frequency band is referred to as LF and the high frequency band is referred to as HF in some cases.

Next, with reference to FIG. 7, adjustment of the resonance frequency in the resonator 10 will be described.

First, the dimension of the resonator 10 will be described.

In the resonator 10 in the exemplary embodiment, the length Lr and the height Hr of the cavity 11 enclosed by the outer conductor 12, the outer diameter D1 of the distal end portion 131, the outer diameter D2 of the movable body 133, the outer diameter D3 of the main body of the supporting body 134 and the outer diameter D4 of the fixing plate 135 are the same (fixed) though the frequency band to be used is different.

On the other hand, the distances h1 to h6 are changed in accordance with the frequency band to be used. To describe further, in the resonator 10 in the exemplary embodiment, the frequency band to be used can be changed by setting the distance h1. Moreover, though the details will be described later, in the resonator 10 in the exemplary embodiment, the temperature drift of frequency in the frequency band to be used is suppressed by adjusting the distance h1.

Note that, in the cavity 11 of the resonator 10, for example, the length of one side Lr is 120 mm and the height Hr is 150 mm. Moreover, the outer diameter D1 of the distal end portion 131 is 45 mm, the outer diameter D2 of the movable body 133 is 35 mm, the outer diameter D3 of the main body of the supporting body 134 is 50 mm, and the outer diameter D4 of the fixing plate 135 is 46 mm.

Incidentally, the distance h1 in the case of the low frequency band (LF) shown in FIG. 7A is set larger as compared to the distance h1 in the case of the high frequency band (HF) shown in FIG. 7B. In other words, the distance h2 in the case of the low frequency band (LF) is smaller than the distance h2 in the case of the high frequency band (HF).

Then, in the exemplary embodiment, by making the distance h1 from the supporting surface portion 123 of the outer conductor 12 to the distal end of the distal end portion 131 variable, it is possible to change the frequency band to be used.

Here, the distance h1 can be obtained based on the frequency band to be used by a simulation (electromagnetic analysis). To additionally describe, the distance h1 can be obtained based on the deformation amount of the outer conductor 12 or others (details will be described later) due to the frequency band to be used and thermal contraction or thermal expansion with temperature change in a predetermined temperature range.

Note that the distances h2 to h6 are determined by setting the distance h1. From this, it may be possible that any of the distances h2 to h6 is obtained by a simulation, and the distance h1 is determined based on the result thereof.

### <Adjusting Method of Resonator 10>

Here, an adjusting method of the resonator 10 will be described.

First, as a premise, when the resonator 10 is to be adjusted, there is a state in which the fixing plate 135 has not been attached to the movable body 133 and the supporting body 134.

Then, when the frequency band in which the resonator 10 is to be used is determined, while performing positional adjustment of the movable body 133 in the axial direction, the inner conductor 13 is disposed so that the distance h1 obtained in advance by a simulation is provided. At this time, by rotating (twisting) the movable body 133 in the circumferential direction, the distance h1 is adjusted.

Note that the distance h1 is determined by the sum of the distance h5 and the distance h6. Moreover, the distance h6 is a fixed value determined by the dimension of the supporting body 134. Consequently, for example, the inner conductor 13 is disposed at the position obtained by the simulation while twisting the movable body 133 and measuring the distance h5.

Then, in the state where the positional adjustment of the movable body 133 in the axial direction has been completed, the fixing plate 135 and the bolts (not shown) are attached to the movable body 133 and the supporting body 134 as described above. This suppresses the displacement of the movable body 133 with respect to the supporting body 134.

From above, setting of the resonator 10 is carried out, and handling for the frequency band in which the resonator 10 is to be used is completed.

Note that, in the filter 100 shown in FIG. 2, the distance h1 of each of the resonators 10-1 to 10-6 may be set differently from one another in accordance with characteristics of the filter 100, such as the passing frequency band.

Moreover, when the frequency band in which the resonator 10 is to be used is readjusted, the fixing plate 135 and the bolts (not shown) are detached, and the body 133 is disposed at the desired position while being rotated in the circumferential direction, and thereafter, the movable body 133 is fixed again via the fixing plate 135 and the bolts. In this manner, the resonator 10 in the exemplary embodiment can easily change the frequency band.

### <Mechanical Vibration>

By the way, as described above, in the exemplary embodiment, on the outer circumferential surface of the movable body 133 and the inner circumferential surface of the through hole 134b of the supporting body 134, the screw grooves 133t and the screw grooves 134t are formed, respectively, and these screw grooves are engaged with each other and fixed by the fixing plate 135.

This makes it possible that the resonator 10 is able to endure mechanical vibration in a state where electrical contact between the inner conductor 13 and the outer conductor 12 is secured. In other words, vibration proof of the resonator 10 (the filter 100) is improved and contact resistance of the inner conductor 13 and the outer conductor 12 is reduced. Moreover, since the movable body 133 is smoothly moved in the axial direction and the position thereof is fixed by rotation of the inner conductor 13, it becomes easy to adjust the projection amount of the movable body 133 (refer to the distance h5) and to fix the movable body 133.

Here, as a structure to variably support the inner conductor 13, different from the exemplary embodiment, a mode that uses a so-called finger (not shown), which is an elastically-deformable supporting member, fixed to the outer conductor 12 can be considered. To describe further, by supporting the inner conductor 13 while pressing the outer circumference of the inner conductor 13 by the finger, it is possible to secure the electrical contact of the inner conductor 13 and the outer conductor 12 via the finger, to thereby smoothly change the position of the inner conductor 13.

However, in the mode using the finger, the outer circumferential surface of the inner conductor 13 is pressed by an elastic force of the finger and the inner conductor 13 is fixed by a frictional force between the outer circumferential surface and the finger; therefore, when the mechanical vibration is applied, the position of the inner conductor 13 can be possibly shifted. Consequently, it is necessary to fix the inner conductor 13 by other fixing members or the like.

Therefore, in the exemplary embodiment, the screw grooves 133t and 134t are provided to the region where the outer circumferential surface of the movable body 133 and the inner circumferential surface of the through hole 134b of the supporting body 134 faced each other to be able to endure the mechanical vibration, as compared to the mode of the finger.

### <Suppression of Reduction in Qu Value>

Incidentally, as described above, the screw grooves 133t are provided on the outer circumferential surface of the movable body 133. In other words, the movable body 133 is formed in a male-screw shape. This increases the surface resistance of the entire inner conductor 13, and as a result, possibly leads to reduction in a Qu value.

Therefore, on the outer circumferential surface of the movable body 133 in the exemplary embodiment, the flat portions 133h are provided. Due to that the flat portions 133h are formed, reduction in the Qu value is suppressed, as compared to a configuration in which the flat portions 133h are not formed, namely, a configuration in which the screw portion 133g is formed on the whole circumference of the fixed portion 133c of the movable body 133.

Note that, as a mechanism of suppressing reduction in the Qu value by forming the flat portions 133h, for example, the following can be considered. That is, by forming the flat portions 133h, a surface area of the movable body 133 (the fixed portion 133c, the inner conductor 13) becomes narrowed, and an electrical pathway in the axial direction is shortened. This is due to a skin effect, and according thereto, electrical resistance of the entire inner conductor 13 is reduced, to thereby suppress reduction in the Qu value. In other words, a good Qu value is obtained, and as a result, passing loss can also be reduced.

Here, description will be given of results of simulations about forming the screw grooves 133t on the outer circumferential surface of the movable body 133 and forming the flat portions 133h. First, different from the exemplary embodiment, in a case where the screw grooves 133t were not formed on the outer circumferential surface of the movable body 133, that is, in a case where the movable body 133 was in a columnar shape, the Qu value was about 9500.

Moreover, different from the exemplary embodiment, in a case where the screw grooves 133t were formed on the whole circumference of the movable body 133, that is, in a case where the screw grooves 133t were formed on the outer circumferential surface of the movable body 133 and the flat portions 133h were not formed, the Qu value was about 7500.

On the other hand, in the case of the movable body 133 of the exemplary embodiment, that is, in the case where the screw grooves 133t were formed on the outer circumferential surface of the movable body 133 and the flat portions 133h were also formed, the Qu value was about 8100.

From the simulation results, it was confirmed that, by forming the flat portions 133h, reduction in the Qu value was suppressed as compared to the case where the flat portions 133h were not formed.

### <Temperature Compensation>

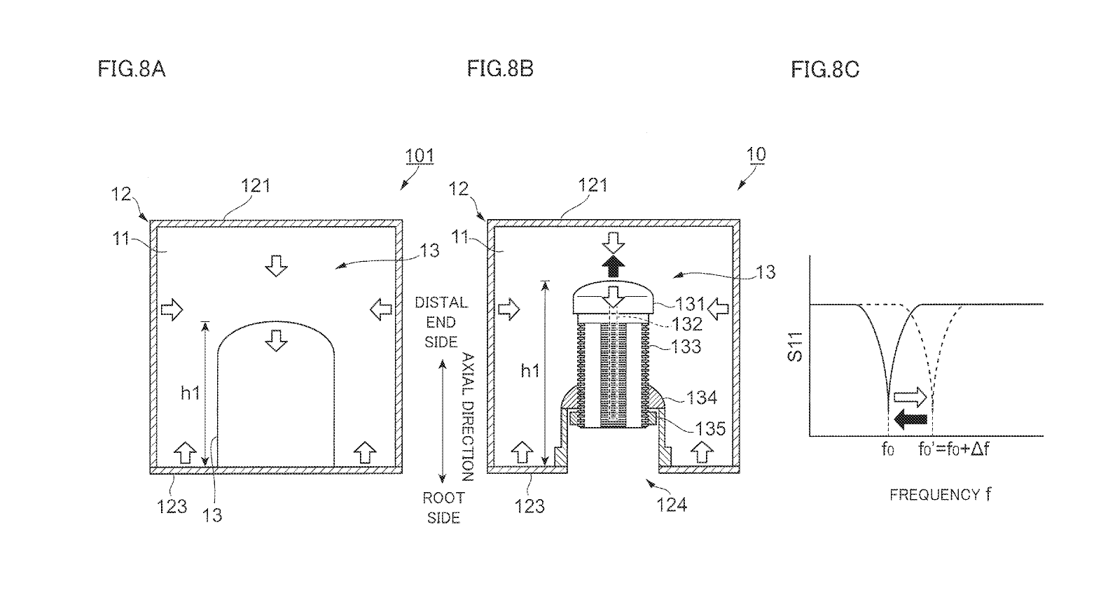

FIGS. 8A to 8C are diagrams for illustrating temperature compensation in the resonator 10. FIG. 8A is a diagram showing a resonator 101 in which, different from the exemplary embodiment, the inner conductor 13 is fixed to the outer conductor 12, FIG. 8B is a diagram showing the resonator 10, which is the exemplary embodiment, that performs temperature compensation as a configuration capable of moving the inner conductor 13 with respect to the outer conductor 12, and FIG. 8C is a diagram illustrating temperature drift of the frequency f by an S parameter S11.

Solid-white arrows and a solid-black arrow drawn in FIGS. 8A and 8B indicate changes in the outer conductor 12 and the inner conductor 13 (directions of contraction) in a case where the temperature of the resonator 10 changes from the temperature T0 to the temperature (T0−ΔT), that is, in a case where the temperature is decreased.

Next, with reference to FIGS. 8A to 8C, the temperature compensation that suppresses the temperature drift of a frequency will be described.

First, the resonator 101 shown in FIG. 8A, which is different from the exemplary embodiment, will be described. In the resonator 101, the inner conductor 13 is fixed to the supporting surface portion 123 of the outer conductor 12. Then, the resonator 101 is not provided with the distal end portion 131, the supporting rod 132, the movable body 133, the supporting body 134 and the fixing plate 135, and therefore, the position of the inner conductor 13 cannot be adjusted.

In this case, when the temperature T0 changes to the temperature (T0−ΔT), the outer conductor 12 and the inner conductor 13 contract in accordance with coefficients of thermal expansion and move in the directions of the solid-white arrows in the figure. At this time, the size of the cavity 11 is reduced and the distance h1 is also reduced. As a result, as shown in FIG. 8C, the center frequency f0 shifts to the center frequency f0′. This is the temperature drift of the frequency.

Next, the resonator 10 in the exemplary embodiment shown in FIG. 8B will be described. In the resonator 10, as described above, the distal end portion 131 of the inner conductor 13 is provided slidably in the axial direction with respect to the movable body 133. Moreover, the distal end portion 131 is connected to the supporting rod 132. Then, as described above, the coefficient of thermal expansion of the supporting rod 132 is smaller than the coefficient of thermal expansion of the outer conductor 12 or the like.

Consequently, also in the configuration shown in FIG. 8B, similar to the configuration shown in FIG. 8A, when the temperature T0 changes to the temperature (T0-ΔT), the outer conductor 12 contracts (moves in the directions of the solid-white arrows) by the thermal contraction. Moreover, the movable body 133 and the supporting body 134 also contract in the axial direction (move in the directions of the solid-white arrows).

Here, the supporting rod 132 also contracts in the axial direction. However, since the coefficient of thermal expansion of the supporting rod 132 is small, the length of contraction in the axial direction (the deformation amount) of the supporting rod 132 is short as compared to the movable body 133. Due to the difference in the deformation amount, the supporting rod 132 causes the distal end portion 131 of the inner conductor 13 to move in the direction of pressing into (entering) the cavity 11 (moves in the direction of the solid-black arrow). To put it another way, the supporting rod 132 with the small coefficient of thermal expansion is brought into a state of pushing inside the inner conductor 13.

Consequently, even if the movable body 133 and the supporting body 134 contract (move in the directions of the solid-white arrows) by thermal contraction, since the distal end portion 131 of the inner conductor 13 is moved in the direction of pressing into (entering) the cavity 11 (moves in the direction of the solid-black arrow) by the supporting rod 132, decrease of the distance h1 is suppressed.

As a result, the center frequency f0 does not shift to the center frequency f0′, and thereby the center frequency f0 is maintained.

In the meantime, in a case where the temperature T0 changes to the temperature (T0=ΔT), that is, when the temperature rises in the configuration shown in FIG. 8B, the above description is reversed. In other words, the outer conductor 12 expands, and with the expansion of the movable body 133, the distal end portion 131 of the inner conductor 13 is moved in the direction of being pushed out (going out) of inside of the cavity 11 by the supporting rod 132 with the small coefficient of thermal expansion. That is, increase of the distance h1 is suppressed. Consequently, the center frequency f0 does not shift, and thereby the center frequency f0 is maintained.

In this manner, by making the coefficient of thermal expansion of the supporting rod 132 smaller, in particular, than the outer conductor 12 and the movable body 133, the distal end of the inner conductor 13 moves in the direction of being pushed into the cavity 11 (in the direction of the solid-black arrow) when the temperature drops, and the distal end of the inner conductor 13 moves in the direction of being pushed out of the cavity 11 (in the direction of the solid-white arrow) when the temperature rises; accordingly, the temperature drift of the frequency is suppressed.

Note that the moving amount of the inner conductor 13 with respect to the cavity 11 due to the temperature change is set to suppress temperature shift of the frequency within a predetermined temperature range, for example, from −10° C. to 45° C.

### <Relationship Between Frequency Band and Temperature Compensation Amount>

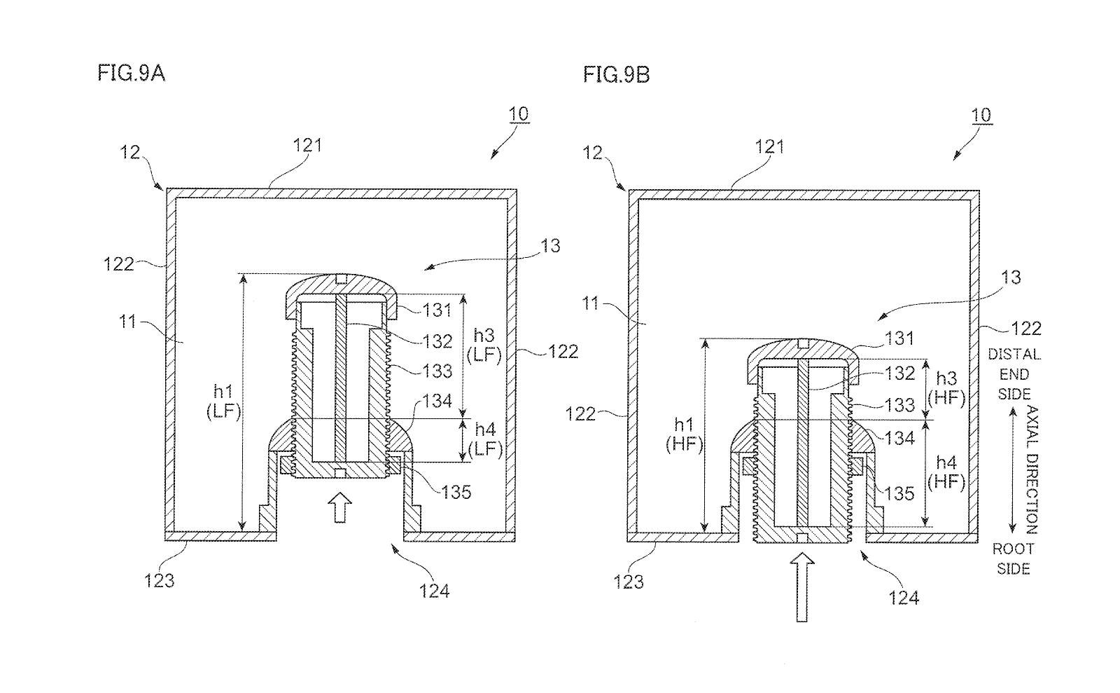

FIGS. 9A and 9B are diagrams for illustrating a relationship between the passing frequency band and the temperature compensation amount in the resonator 10. To describe further, FIG. 9A shows a case in which the frequency band is low (the low frequency band) and FIG. 9B shows a case in which the frequency band is high (the high frequency band).

Next, with reference to FIGS. 9A and 9B, a relationship between the passing frequency band and the temperature compensation amount in the resonator 10 will be described. In other words, description will be given of the change in the temperature compensation amount with the movement of the movable body 133 in the axial direction in the resonator 10.

First, as described above, the distance h1 in the case of the low frequency band (LF) is set larger as compared to the distance h1 in the case of the high frequency band (HF). Consequently, the distance h3 in the case of the high frequency band (HF) becomes smaller as compared to the distance h3 in the case of the low frequency band (LF). Moreover, the distance h4 in the case of the high frequency band (HF) becomes larger as compared to the distance h4 in the case of the low frequency band (LF).

Next, in the dispositions shown in FIGS. 9A and 9B, a case where the temperature of the resonator 10 changes from the temperature T0 to the temperature (T0-ΔT), that is, a case where the temperature is decreased will be considered. Due to the temperature decrease, the supporting rod 132 also contracts, although the deformation amount is less than the movable body 133.

Here, the distance h3 in the case of the high frequency band (HF) is smaller as compared to the distance h3 in the case of the low frequency band (LF). Consequently, though it is supposed that there is the same amount (ΔT) of temperature decrease, the deformation amount of the distance h3 becomes smaller in the case of the high frequency band of the shorter length. As a result, changes in the distance h1 are suppressed more in the case of the high frequency band as compared to the case of the low frequency band. In other words, the higher the frequency band is, the larger the action in the direction of counteracting the effect of thermal deformation becomes; as a result, the amount of temperature compensation is increased.

Note that the change in the temperature compensation amount can be grasped from a standpoint of disposition of the movable body 133.

First, the movable body 133 is in a state of being supported by the supporting body 134 at the midpoint in the axial direction (at an intermediate position in the axial direction). Therefore, when the movable body 133 contracts with the temperature decrease, an end portion on the root side of the movable body 133 moves in the direction toward the distal end side (moves in the direction of the solid-white arrow).

Here, as shown in FIGS. 9A and 9B, the distance h4 of the high frequency band (HF) is larger than the distance h4 of the low frequency band (LF). In other words, the length of the root side in the movable body 133, that is, the length in the axial direction from the end portion on the root side in the movable body 133 to the distal end of the supporting body 134 is longer in the high frequency band. Therefore, though it is supposed that there is the same amount (ΔT) of temperature decrease, the amount of changes in the length of the root side becomes larger in the case of the high frequency band. As a result, the end portion on the root side of the movable body 133 moves larger in the direction heading for the distal end side in the case of the high frequency band.

At this time, the supporting rod 132 fixed to the end portion on the root side of the movable body 133 moves larger in the direction in which the distal end portion 131 is pushed into (enters) the inside of the cavity 11 in the case of the high frequency band, as compared to the case of the low frequency band. As a result, changes in the distance h1 are suppressed more in the case of the high frequency band as compared to the case of the low frequency band. In other words, the higher the frequency band is, the larger the action in the direction of counteracting the effect of thermal deformation becomes; as a result, the amount of temperature compensation is increased.

### <Sliding Movement of Distal End Portion 131>

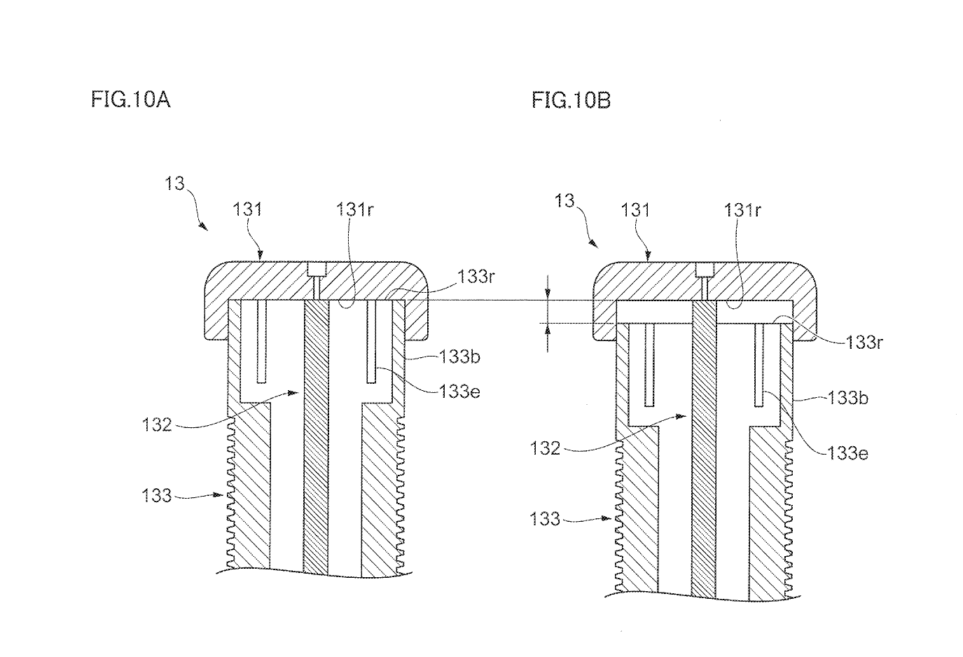

FIGS. 10A and 10B are diagrams for illustrating sliding movement of the distal end portion 131. To describe further, FIG. 10A shows a case of the higher temperature as compared to the temperature when the resonator 10 is adjusted, and FIG. 10B shows a case of the lower temperature as compared to the temperature when the resonator 10 is adjusted. Moreover, it is supposed that the frequency band in FIGS. 10A and 10B are the same.

Next, with reference to FIGS. 10A and 10B, the sliding movement of the distal end portion 131 will be described.

First, in the exemplary embodiment, as described above, the distal end portion 131 is connected to the movable body 133 and the supporting rod 132. Then, by changing the distance in the axial direction between the distal end portion 131 and the movable body 133 by the supporting rod 132, the temperature compensation is performed.

To describe specifically, as shown in FIGS. 10A and 10B, the distance between a surface 131r on the movable body 133 side (root side) of the distal end portion 131 and a surface 133r on the distal end portion 131 side (distal end side) of the movable body 133 is changed corresponding to the temperature. Note that the distance becomes larger in the case of low temperature (refer to FIG. 10B).

Here, when the distance in the axial direction between the distal end portion 131 and the movable body 133 is changed, the distal end portion 131 is subjected to sliding movement in a state where the second concave portion 131d (refer to FIG. 5A), which is the inner circumferential surface of the distal end portion 131 is supported by the outer circumferential surface of the slide supporting portion 133b of the movable body 133, as described above.

Moreover, in the exemplary embodiment, irregularities, such as the screw grooves 133t, are not formed on the outer circumferential surface of the slide supporting portion 133b. Moreover, the slide supporting portion 133b is elastically deformed in the diameter direction. As a result, it becomes possible to smoothly perform the sliding movement of the distal end portion 131. Then, due to the sliding movement being smoothly performed, the temperature compensation is securely performed, and as a result, adjustment of the resonance frequency is made easier. Moreover, by the elastic deformation of the slide supporting portion 133b, electrical connection between the distal end portion 131 and the movable body 133 is stably maintained.

Note that the length of the supporting rod 132 in the axial direction can be determined based on a distance in the axial direction between the distal end portion 131 and the movable body 133 required to perform desired temperature compensation.

### <BPF Characteristics>

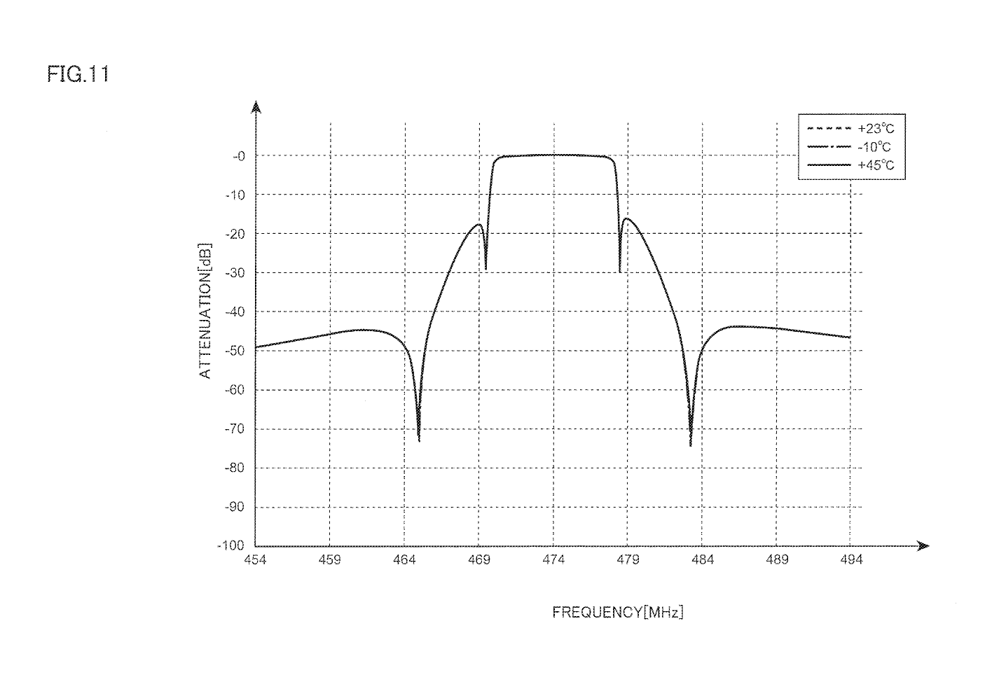

FIG. 11 is a diagram showing temperature change in attenuation when the center frequency f0 is set to 474 MHz (low frequency band) in the filter 100.

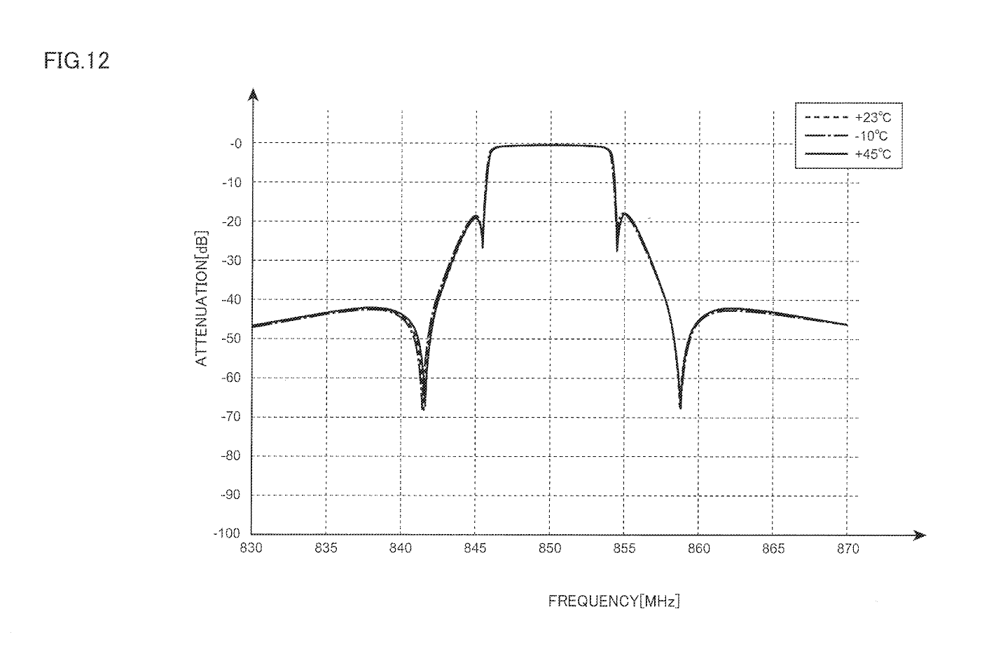

FIG. 12 is a diagram showing temperature change in attenuation when the center frequency f0 is set to 850 MHz (high frequency band) in the filter 100.

Note that, in FIGS. 11 and 12, the filter 100, in which six resonators 10 are coupled as shown in FIG. 2, is used.

Next, with reference to FIGS. 11 and 12, description will be given of measuring results of temperature change of the attenuation in the filter 100 shown in FIG. 2.

Here, in FIGS. 11 and 12, as the filter 100, a configuration in which six resonators 10 shown in FIGS. 3A and 3B are coupled is used (refer to FIG. 2). Moreover, here, in FIGS. 11 and 12, the temperature is changed in the order of 23° C., −10° C., 45° C. and 23° C.

As shown in FIG. 11, in the case of the low frequency band setting the center frequency f0 at 474 MHz, in the above-described temperature range, there is little change in the attenuation, and also the passing frequency band (470 MHz to 478 MHz) shows almost no variation (temperature drift).

Moreover, as shown in FIG. 12, in the case of the high frequency band setting the center frequency f0 at 850 MHz, in the above-described temperature range, the attenuation slightly changes, but the passing frequency band (846 MHz to 856 MHz) shows almost no variation (temperature drift).

As described above, as shown in FIGS. 11 and 12, in the filter 100 using the resonator 10 shown in FIGS. 3A and 3B, it was confirmed that, in the wide band with the center frequency f0 of 474 MHz to 850 MHz, high temperature stability in the temperature range from −10° C. to +45° C. was obtained.

### <Resonator Characteristics>

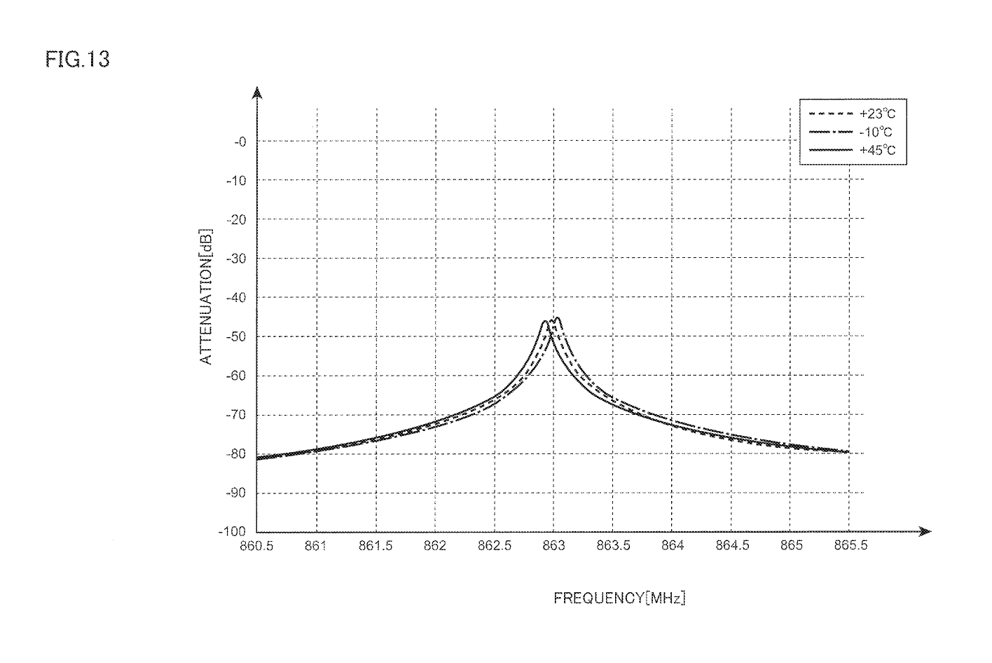

FIG. 13 is a diagram showing temperature change in the attenuation when the center frequency f0 is set to 863 MHz (high frequency band) in a single resonator 10.

Next, with reference to FIG. 13, description will be given of measuring results of temperature change of the attenuation in the single resonator 10 shown in FIGS. 3A and 3B.

Note that, while the filter 100, in which six resonators 10 are coupled, is used in FIGS. 11 and 12, there is only one resonator 10 in the configuration in FIG. 13. Moreover, similar to FIGS. 11 and 12, the temperature is changed in the order of 23° C., −10° C., 45° C. and 23° C.

As shown in FIG. 13, in the above-described temperature range, there is little change in the attenuation, and also, almost no temperature drift is shown. Consequently, high temperature stability of the resonator 10 is obtained.

Then, as described above, the resonator 10 is able to handle high-power signals and achieves downsizing.

### Modified Examples

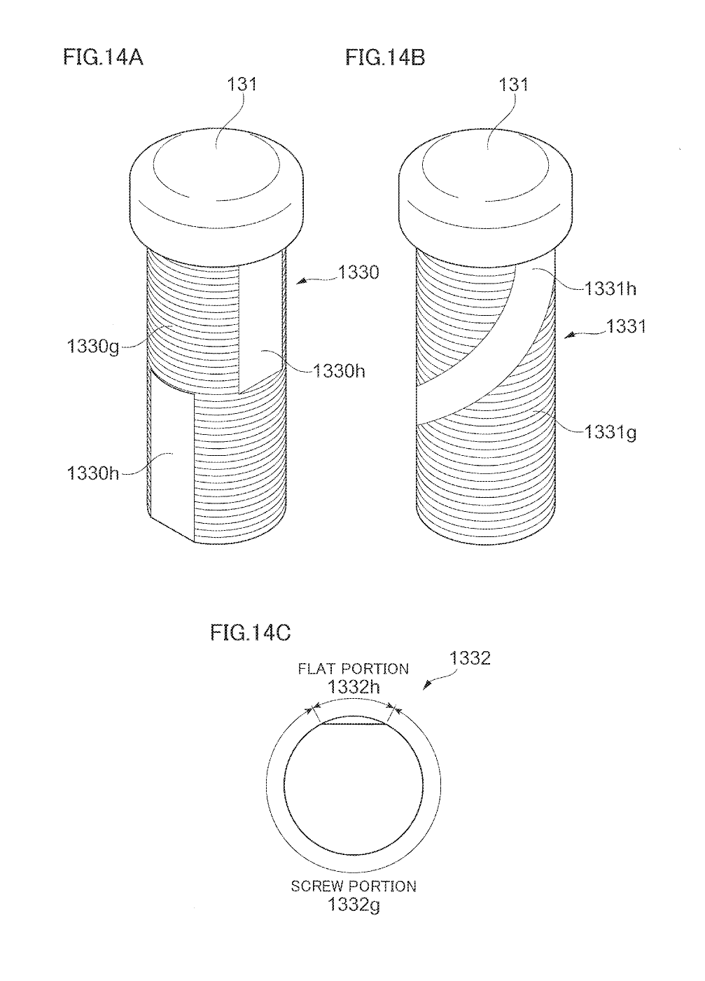

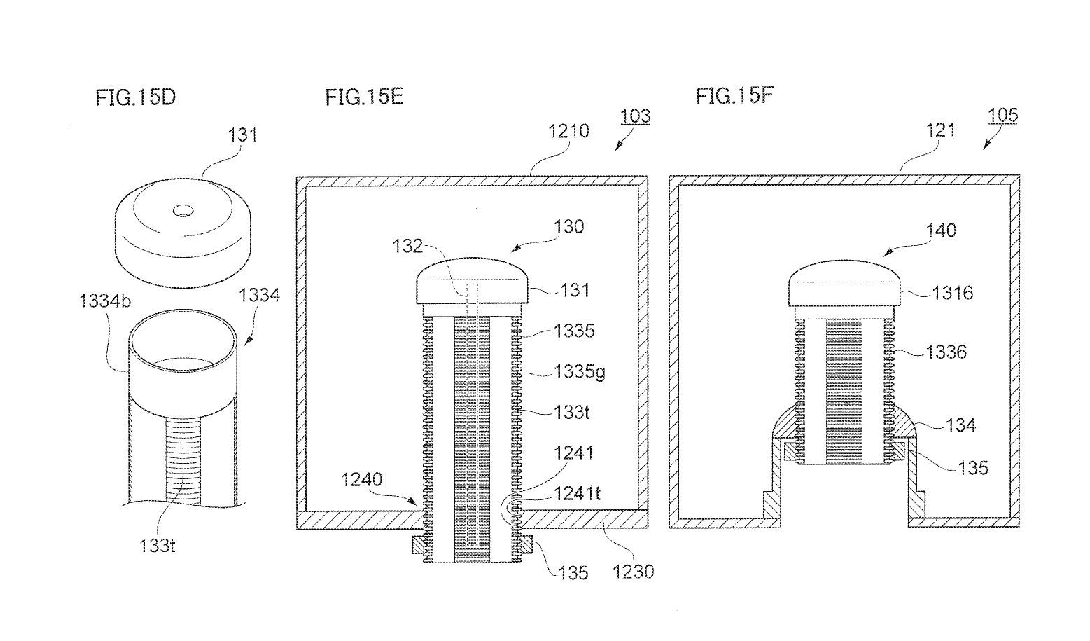

FIGS. 14A to 14C and FIGS. 15D to 15F are diagrams illustrating modified examples in the exemplary embodiment.

Next, with reference to FIGS. 14A to 14C and FIGS. 15D to 15F, modified examples in the exemplary embodiment will be described. Note that, in the following description, configurations similar to the above-described configurations are assigned with same reference signs, and detailed descriptions thereof will be omitted.

In the above, the filter 100 of the exemplary embodiment has been described with reference to FIGS. 1 to 13; however, in the filter 100, various modified examples can be considered.

First, in the above, it has been described that the flat portion 133h linearly extended along the axial direction; however, the exemplary embodiment is not limited thereto.

For example, as a movable body 1330 shown in FIG. 14A, the exemplary embodiment may have a configuration including a screw portion 1330g and a flat portions 1330h that are not continuous in the axial direction.

Moreover, for example, as a movable body 1331 shown in FIG. 14B, the exemplary embodiment may have a configuration including a screw portion 1331g and a flat portion 1331h spirally formed to gyrate around the outer circumferential surface of the movable body 1331.

Moreover, in the above, it has been described that the multiple flat portions 133h were formed along the circumferential direction; however, the exemplary embodiment is not limited thereto.

For example, as a movable body 1332 shown in FIG. 14C, the exemplary embodiment may have a configuration including a single flat portion 1332h in the circumferential direction. In the movable body 1332, a single screw portion 1332g is formed in the circumferential direction. Note that, regarding the length in the circumferential direction in the shown example, the length in the screw portion 1332g is longer than that in the flat portion 1332h.

Here, though illustration thereof is omitted, the number of each of the screw portions 133g and the flat portions 133h may be, of course, 2, 3 or 5 or more. Moreover, regardless of the number of screw portions 133g and flat portions 133h, as for the length in the circumferential direction, the sum total of all the screw portions 133g and the sum total of all the flat portions 133h may be equal, or any one of which may be longer.

Moreover, in the above, it has been described that the flat portion 133h is a flat surface; however, the exemplary embodiment is not limited thereto. Though illustration thereof is omitted, the flat portion 133h may not include the screw grooves 133t formed thereon; for example, the flat portion 133h may be configured as a curved surface or a surface including irregularities.

Moreover, in the above, it has been described that the slide supporting portion 133b is provided with the multiple slits 133e in the circumferential direction; however, the exemplary embodiment is not limited thereto. Though illustration thereof is omitted, for example, it may be possible to have a configuration including a single slit 133e.

Alternatively, as a movable body 1334 shown in FIG. 15D, it may be possible to have a configuration not including any slit 133e. In this configuration, for example, by forming the slide supporting portion 1334b by, for example, a member having a high coefficient of elasticity or by forming thereof in a thinner shape, the outer diameter of the slide supporting portion 1334b becomes variable.

Incidentally, in the above, it has been described that the inner conductor 13 has the configuration including the distal end portion 131, the supporting rod 132, the movable body 133, the supporting body 134 and the fixing plate 135; however, the exemplary embodiment is not limited thereto.

For example, as an inner conductor 130 shown in FIG. 15E, it may be possible to have a configuration not provided with the supporting body 134. In a resonator 103 not including the supporting body 134, on a supporting surface portion 1230 of an outer conductor 1210, an opening section 1240, into which the inner conductor 130 is inserted, is formed. Moreover, screw grooves 1241t are formed on an inner circumferential surface 1241 of the opening section 1240.

Then, due to the screw grooves 1241t of the opening section 1240 and the screw grooves 133t of the screw portion 1335g of the movable body 1335 engaging with each other, it becomes possible to adjust the position of the movable body 1335 in the axial direction while the movable body 1335 endures the mechanical vibration.

Alternately, as an inner conductor 140 shown in FIG. 15F, it may be possible to have a configuration not provided with the supporting rod 132. In a resonator 105 not including the supporting rod 132, a distal end portion 1316 and a movable body 1336 are configured as an integrated member, not separate members. Note that, different from the inner conductor 140 shown in FIG. 15F, it may be possible to have a configuration in which the distal end portion 131 and the movable body 133 are configured as separate members, as the above-described distal end portion 131 and movable body 133, and are fixed to each by a known fixing tool, for example, bolts.

Further, though illustration is omitted, it may be possible to have a configuration in which the outer circumferential surface of the movable body 133 is not provided with the screw grooves 133t. In other words, for example, different from the above-described inner conductor 13 or the like, an inner conductor (not shown) may be configured to include a movable body not being provided with the screw grooves 133t (not shown), the distal end portion 131 provided to the distal end of the movable body, and the supporting rod 132 both ends thereof being connected to the movable body and the distal end portion 131.

In the above, various exemplary embodiments and modified examples have been described; however, it may be possible, of course, to have configurations by combining the exemplary embodiments and the modified examples.

Moreover, the disclosure is not limited to the above-described exemplary embodiment, and is able to be put into practice in various forms within the scope not departing from the gist of the disclosure.

### REFERENCE SIGNS LIST

10, 10-1 to 10-6 . . . Resonator
11 . . . Cavity
12 . . . Outer conductor
13 . . . Inner conductor
100 . . . Filter
131 . . . Distal end portion
132 . . . Supporting rod
133 . . . Movable body
133b . . . Slide supporting portion
133c . . . Fixed portion
133g . . . Screw portion
133h . . . Flat portion
134 . . . Supporting body
135 . . . Fixing plate

1-12. (canceled)

13. A resonator comprising:
an outer conductor that forms a cavity inside thereof; and
an inner conductor provided in the cavity of the outer conductor,
wherein the inner conductor comprises:
a hollow member provided to project into the cavity;
a covering member that is a separate member from the hollow member and covers a distal end in the hollow member, which is on a side projecting into the cavity; and
a supporting rod that is a rod-shaped member disposed inside the hollow member and provided with one end side thereof being fixed to the covering member and the other end side being fixed to the hollow member, the supporting rod having a coefficient of thermal expansion lower than a coefficient of thermal expansion of the hollow member, and
wherein the distal end side of the hollow member is elastically more deformable than a root side of the hollow member.

14. The resonator according to claim 13, wherein the covering member covers the distal end and an outer circumferential side surface of the distal end side of the hollow member, and
wherein the outer circumferential side surface of the hollow member slidably supports the covering member along the projecting direction.

15. A resonator comprising:
an outer conductor that forms a cavity inside thereof; and
an inner conductor provided in the cavity of the outer conductor,
wherein the inner conductor comprises:
a hollow member provided to project into the cavity;
a covering member that is a separate member from the hollow member and covers a distal end in the hollow member, which is on a side projecting into the cavity; and
a supporting rod that is a rod-shaped member disposed inside the hollow member and provided with one end side thereof being fixed to the covering member and the other end side being fixed to the hollow member, the supporting rod having a coefficient of thermal expansion lower than a coefficient of thermal expansion of the hollow member, and
wherein a position of the hollow member in the projecting direction in the cavity is adjustable, and
wherein the hollow member is fixed to the outer conductor at an intermediate position located between the one end and the other end of the supporting rod in the projecting direction.

16. A resonator comprising:
an outer conductor that forms a cavity inside thereof; and
an inner conductor provided in the cavity of the outer conductor,
wherein the inner conductor comprises:
a hollow member provided to project into the cavity;
a covering member that is a separate member from the hollow member and covers a distal end in the hollow member, which is on a side projecting into the cavity; and
a supporting rod that is a rod-shaped member disposed inside the hollow member and provided with one end side thereof being fixed to the covering member and the other end side being fixed to the hollow member, the supporting rod having a coefficient of thermal expansion lower than a coefficient of thermal expansion of the hollow member, and
wherein the inner conductor includes a supporting body that is fixed to the outer conductor in the cavity and supports the hollow member while being penetrated by the hollow member, and
wherein the hollow member and the supporting body include screw grooves on respective surfaces facing each other, and the supporting body supports the hollow member by engaging the screw grooves each other.

17. A filter comprising:
an input unit to which a signal is inputted;
an output unit from which a signal is outputted; and
a resonator that is connected to the input unit and the output unit, and includes an outer conductor forming a cavity inside thereof and an inner conductor provided in the cavity of the outer conductor,
wherein the inner conductor comprises:
a hollow member provided to project into the cavity;
a covering member that is a separate member from the hollow member and covers a distal end in the hollow member, which is on a side projecting into the cavity; and
a supporting rod that is a rod-shaped member disposed inside the hollow member and provided with one end side thereof being fixed to the covering member and the other end side being fixed to the hollow member, the supporting rod having a coefficient of thermal expansion lower than a coefficient of thermal expansion of the hollow member, and
wherein the distal end side of the hollow member is elastically more deformable than a root side of the hollow member.

18. A resonator comprising:
an outer conductor that forms a cavity inside thereof; and
an inner conductor provided to project into the cavity of the outer conductor, a position of the inner conductor inside the cavity being adjustable,
wherein the inner conductor includes a screw groove formed on an outer circumferential surface of the inner conductor along a circumferential direction of the inner conductor to allow for adjustment of the position,
wherein a region where the screw groove is formed includes a discontinuous portion in which the screw groove is not continuous in the circumferential direction, and
wherein the inner conductor includes a non screw-groove forming portion in which the screw groove is not formed over a predetermined length from a distal end side projecting into the cavity of the outer conductor.

19. The resonator according to claim 18, wherein the discontinuous portion extends from a root side toward the distal end side with a constant length in the circumferential direction.

20. The resonator according to claim 18, wherein a plurality of the discontinuous portions are provided at positions different from one another in the circumferential direction.

21. The resonator according to claim 18, wherein the inner conductor comprises:
a main body that is movable in the projecting direction inside the cavity and includes the screw groove on an outer circumferential surface thereof; and
a supporting body that is fixed to the outer conductor inside the cavity and supports the main body while being penetrated by the main body, and
wherein the supporting body includes another screw groove, which engages the screw groove, on an inner circumferential surface facing the main body that penetrates the supporting body.

22. The resonator according to claim 21, wherein the inner conductor includes a rotation suppressing member that suppresses rotation of the main body with respect to the supporting body.

23. The resonator according to claim 21, wherein the inner conductor is supported by the non screw-groove forming portion and includes a covering member that covers the distal end side than the screw groove in the inner conductor.

24. A filter comprising:
an input unit to which a signal is inputted;
an output unit from which a signal is outputted; and
a resonator that is connected to the input unit and the output unit, and includes an outer conductor forming a cavity inside thereof and an inner conductor provided inside the cavity of the outer conductor, a position of the inner conductor in the cavity being adjustable,
wherein the inner conductor includes a screw groove formed on an outer circumferential surface of the inner conductor along a circumferential direction of the inner conductor to allow for adjustment of the position,
wherein a region where the screw groove is formed includes a discontinuous portion in which the screw groove is not continuous in the circumferential direction, and
wherein the inner conductor includes a non screw-groove forming portion in which the screw groove is not formed over a predetermined length from a distal end side projecting into the cavity of the outer conductor.
